(19) United States
(12) Patent Application Publication
(10) Pub. No.: US 2023/0164578 A1
(43) Pub. Date: May 25, 2023

(54) CARRIER SELECTION IN THE DISTRIBUTIVE DUAL BAND CARRIER AGGREGATION SYSTEM

(71) Applicant: QUALCOMM Incorporated, San Diego, CA (US)

(72) Inventors: Arthur GUBESKYS, San Diego, CA (US); Shuanshuan WU, San Diego, CA (US); Stelios STEFANATOS, San Diego, CA (US)

(21) Appl. No.: 17/921,557

(22) PCT Filed: Jun. 23, 2021
(86) PCT No.: PCT/US2021/038729

§ 371 Date: Oct. 26, 2022

(30) Foreign Application Priority Data
Jun. 24, 2020 (GR) 20200100368

(51) Int. Cl. H04W 16/14; H04W 76/14

(52) U.S. Cl. CPC H04W 16/14; H04W 76/14

(57) ABSTRACT

Aspects of the present disclosure provide apparatus, methods, processing systems, and computer readable mediums for channel selection in systems that utilize both licensed and unlicensed frequency bands. As will be described in greater detail below, user equipments (UEs) that share unlicensed frequency band may select a channel in an unlicensed frequency band and advertise their channel selection over a licensed frequency band, in an effort to coordinate communications other UEs. An example method may include selecting at least a first channel within an unlicensed band for communications with at least a second UE, and transmitting, on a licensed band, an indication of the first channel and location information for the selection.

### PRIORITY CLAIM(S)

This application claims benefit of the priority to Greek Provisional Application No. 20200100368, filed on Jun. 24, 2020, which is expressly incorporated by reference in its entirety as if fully set forth below and for all applicable purposes.

### INTRODUCTION

Aspects of the present disclosure relate to wireless communications, and more particularly, to channel selection in systems that utilize both licensed and unlicensed frequency bands.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

Sidelink communications are communications from one UE to another UE. As the demand for mobile broadband access continues to increase, there exists a need for further improvements in NR and LTE technology, including improvements to sidelink communications. Preferably, these improvements should be applicable to other multi-access technologies and the telecommunication standards that employ these technologies.

Further, as additional resources are deployed in systems, such as both licensed and unlicensed spectrum, various challenges and opportunities arise for optimizing such resources.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description” one will understand how the features of this disclosure provide advantages that include improved device-to-device communications in a wireless network.

Certain aspects of this disclosure provide a method for wireless communication by a first, transmitting, user equipment (UE) for sidelink communication with a second, receiving, UE. The method generally includes monitoring an unlicensed band, selecting at least a first channel within the unlicensed band, based on the monitoring, for communications with at least a second UE, and advertising the first channel and location information for the selection on a licensed band.

Certain aspects of this disclosure provide an apparatus for wireless communication by a first, transmitting, UE for sidelink communication with a second, receiving, UE. The apparatus generally includes means for monitoring an unlicensed band, means for selecting at least a first channel within the unlicensed band, based on the monitoring, for communications with at least a second UE, and means for advertising the first channel and location information for the selection on a licensed band.

Certain aspects of this disclosure provide a computer readable medium storing computer executable code thereon for communications. The computer readable medium generally includes code for monitoring an unlicensed band, selecting at least a first channel within the unlicensed band, based on the monitoring, for communications with at least a second UE, and advertising the first channel and location information for the selection on a licensed band.

Certain aspects of this disclosure provide an apparatus for wireless communications by a first UE. The apparatus generally includes a memory and at least one processor coupled to the memory, the memory and the at least one processor configured to monitor an unlicensed band, select at least a first channel within the unlicensed band, based on the monitoring, for communications with at least a second UE, and advertise the first channel and location information for the selection on a licensed band.

Certain aspects of this disclosure provide a method for wireless communication by a first, transmitting, user equipment (UE) for sidelink communication with a second, receiving, UE. The method generally includes selecting at least a first channel within an unlicensed band for communications with at least a second UE, and transmitting, on a licensed band, an indication of the first channel and location information for the selection.

Certain aspects of this disclosure provide an apparatus for wireless communication by a first, transmitting, UE for sidelink communication with a second, receiving, UE. The apparatus generally includes means for selecting at least a first channel within an unlicensed band for communications with at least a second UE, and means for transmitting, on a licensed band, an indication of the first channel and location information for the selection.

Certain aspects of this disclosure provide a computer readable medium storing computer executable code thereon for communications. The computer readable medium generally includes code for selecting at least a first channel within an unlicensed band for communications with at least a second UE, and transmitting, on a licensed band, an indication of the first channel and location information for the selection.

Certain aspects of this disclosure provide an apparatus for wireless communications by a first UE. The apparatus generally includes a memory and at least one processor coupled to the memory, the memory and the at least one processor configured to select at least a first channel within an unlicensed band for communications with at least a second UE, and transmit, on a licensed band, an indication of the first channel and location information for the selection.

Certain aspects of this disclosure provide a method for wireless communication by a first, transmitting, UE for sidelink communication with a second, receiving, UE. The method generally includes receiving, from a second UE on a licensed band, a first indication of a first channel within an unlicensed band for communications with the second UE, and transmitting, on the licensed band, an indication of a preferred channel and location information for the preferred channel, wherein the preferred channel comprises the first channel or a second channel.

Certain aspects of this disclosure provide an apparatus for wireless communication by a first, transmitting, UE for sidelink communication with a second, receiving, UE. The apparatus generally includes means for receiving, from a second UE on a licensed band, a first indication of a first channel within an unlicensed band for communications with the second UE, and means for transmitting, on a licensed band, an indication of a preferred channel and location information for the preferred channel, wherein the preferred channel comprises the first channel or a second channel.

Certain aspects of this disclosure provide a computer readable medium storing computer executable code thereon for communications. The computer readable medium generally includes code for receiving, from a second UE on a licensed band, a first indication of a first channel within an unlicensed band for communications with the second UE, and transmitting, on a licensed band, an indication of a preferred channel and location information for the preferred channel, wherein the preferred channel comprises the first channel or a second channel.

Certain aspects of this disclosure provide an apparatus for wireless communications by a first UE. The apparatus generally includes a memory and at least one processor coupled to the memory, the memory and the at least one processor configured to receive, from a second UE on a licensed band, a first indication of a first channel within an unlicensed band for communications with the second UE, and transmit, on a licensed band, an indication of a preferred channel and location information for the preferred channel, wherein the preferred channel comprises the first channel or a second channel.

Certain aspects of this disclosure provide a method for wireless communication by a first, transmitting, user equipment (UE) for sidelink communication with a second, receiving, UE. The method generally includes monitoring an unlicensed band, selecting at least a first channel within the unlicensed band, based on the monitoring, for communications with at least a second UE, and advertising the first channel and location information for the selection on a licensed band.

Certain aspects of this disclosure provide an apparatus for wireless communication by a first, transmitting, user equipment (UE) for sidelink communication with a second, receiving, UE. The apparatus generally includes means for monitoring an unlicensed band, means for selecting at least a first channel within the unlicensed band, based on the monitoring, for communications with at least a second UE, and means for advertising the first channel and location information for the selection on a licensed band.

Certain aspects of this disclosure provide a computer readable medium storing computer executable code thereon for communications. The computer readable medium generally includes code for monitoring an unlicensed band, code for selecting at least a first channel within the unlicensed band, based on the monitoring, for communications with at least a second UE, and code for advertising the first channel and location information for the selection on a licensed band.

Certain aspects of this disclosure provide an apparatus for wireless communications by a first user equipment (UE). The apparatus generally includes a memory and at least one processor coupled to the memory, the memory and the at least one processor configured to monitor an unlicensed band, select at least a first channel within the unlicensed band, based on the monitoring, for communications with at least a second UE, and advertise the first channel and location information for the selection on a licensed band.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram illustrating an example logical architecture of a distributed radio access network (RAN), in accordance with certain aspects of the present disclosure.

FIG. 3 is a block diagram conceptually illustrating a design of an example base station (BS) and user equipment (UE), in accordance with certain aspects of the present disclosure.

FIGS. 4A and 4B show diagrammatic representations of example vehicle to everything (V2X) systems in accordance with some aspects of the present disclosure.

FIG. 5 is a schematic diagram illustrating an example network of multiple CV2X devices operating in an unlicensed spectrum, in accordance with certain aspects of the present disclosure.

FIGS. 6 and 8 illustrate example operations for wireless communications by a UE, in accordance with certain aspects of the present disclosure.

FIG. 7 illustrates an example algorithm for selecting a channel, in accordance with certain aspects of the present disclosure.

FIGS. 9A-9C, 10A-10B, and 11A-11B illustrate various use cases for applying channel selection, in accordance with certain aspects of the present disclosure.

FIG. 12 illustrates a communications device that may include various components configured to perform the operations illustrated in FIG. 6, in accordance with certain aspects of the present disclosure.

FIG. 13 illustrates a communications device that may include various components configured to perform the operations illustrated in FIG. 8, in accordance with certain aspects of the present disclosure.

FIG. 14 illustrates example operations for wireless communications by a UE, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for channel selection in systems that utilize both licensed and unlicensed frequency bands. In distributed systems, such as V2X systems where UEs communicate between each other, channel sensing is done by each UE independently. Thus, the result on which channel is best for communication between UEs may not be the same for all the UEs, as different UEs can individually select different channels. Aspects of the present disclosure, however, provide a mechanism that allows UEs within a range (e.g., in an immediate vicinity of each other, for example, within a given range as indicated by zone IDs included in sidelink transmissions by those UEs) to identify a common channel suitable for communication between each other.

As will be described in greater detail below, user equipments (UEs) that share unlicensed frequency band may select a channel in an unlicensed frequency band and advertise (e.g., broadcast for the benefit of other UEs) their channel selection over a licensed frequency band, in an effort to coordinate communications with other UEs. In some cases, a transmission of an indication of a selected channel and location information may be considered “advertising” of such information.

By advertising selected (e.g., preferred) channels in this manner, UEs within a vicinity of each other (e.g., within transmission range) effectively participate in a best effort procedure to use the same channel in the unlicensed band. As used in this context, best effort generally refers to the possibility that the channels advertised by a UE may be selected based on the best efforts of that UE, but, in one or more examples, may not necessarily be ideal or optimal. Advertising selected channels in this manner utilizes the licensed band to facilitate broadcast/multicast communication between UEs in a relatively efficient manner.

Examples described below provide an efficient structure for advertising selected channels. UEs receiving such a structure may decide, based on an algorithm, whether to switch to a channel selected by another UE or maintain a current channel selection. The algorithm may take into account various factors, such as, for example, whether the advertising UE is a stationary roadside unit (RSU) and/or a geographic zone of the advertising UE. Aspects of the present disclosure may assign certain V-UEs, such as stationary nodes (e.g., RSUs), higher priority in the carrier selection process.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

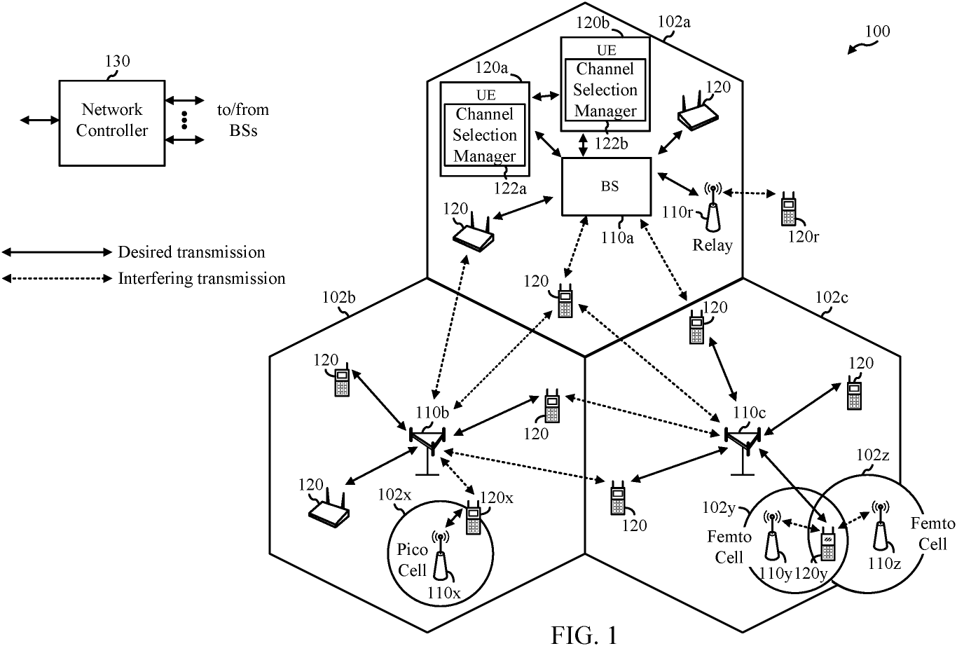

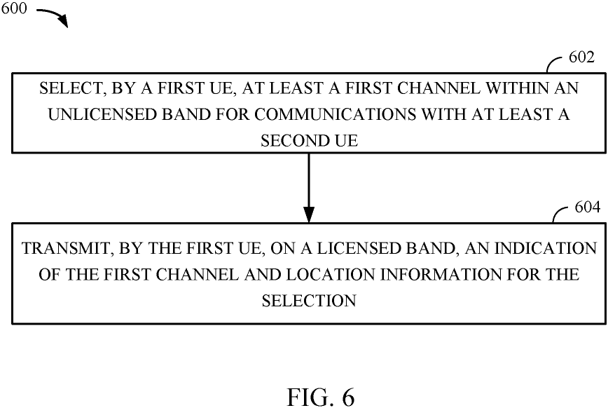

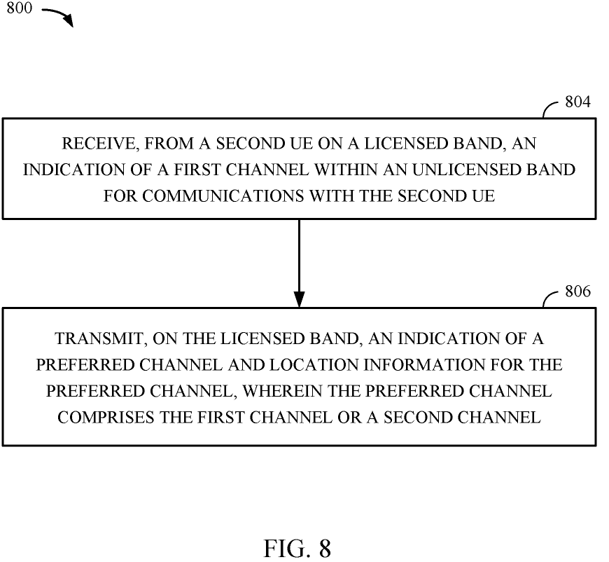

FIG. 1 illustrates an example wireless communication network 100 in which aspects of the present disclosure may be performed. For example, one or more UEs 120a, 120b of FIG. 1 may be vehicle UEs (V-UEs) each with a channel selection manager 122a, 122b, respectively, configured to perform operations described below with reference to FIGS. 6, 8, and/or 14 (respectively) to select a channel on an unlicensed frequency band and advertise their channel selection over a licensed frequency band, in an effort to coordinate communications other UEs.

As illustrated in FIG. 1, the wireless communication network 100 may include a number of base stations (BSs) 110a-z (each also individually referred to herein as BS 110 or collectively as BSs 110) and other network entities. In aspects of the present disclosure, a roadside service unit (RSU) may be considered a type of BS, and a BS 110 may be referred to as an RSU. A BS 110 may provide communication coverage for a particular geographic area, sometimes referred to as a “cell”, which may be stationary or may move according to the location of a BS 110 (e.g., a mobile BS). In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells. The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile.

Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may couple to a set of BSs 110 and provide coordination and control for these BSs 110. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smartj ewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

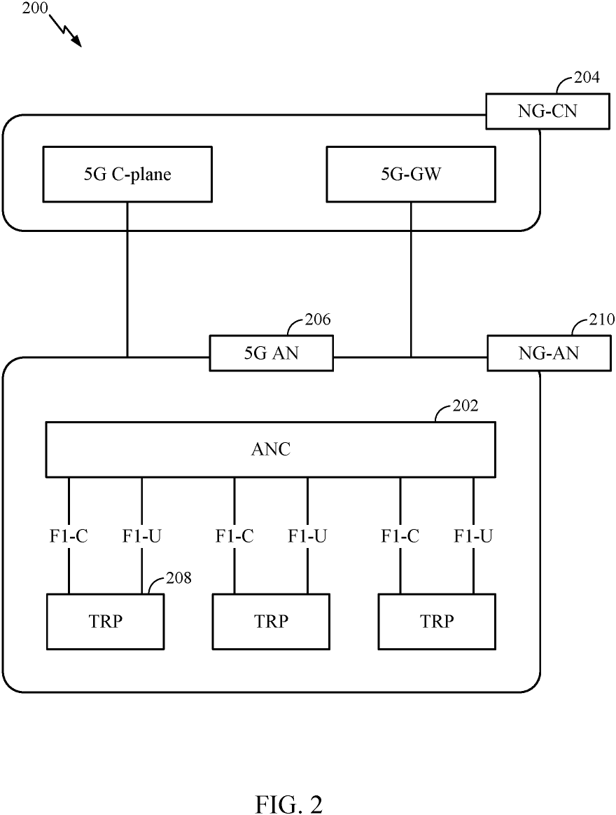

FIG. 2 illustrates an example logical architecture of a distributed Radio Access Network (RAN) 200, which may be implemented in the wireless communication network 100 illustrated in FIG. 1. A 5G access node 206 may include an access node controller (ANC) 202. ANC 202 may be a central unit (CU) of the distributed RAN 200. The backhaul interface to the Next Generation Core Network (NG-CN) 204 may terminate at ANC 202. The backhaul interface to neighboring next generation access Nodes (NG-ANs) 210 may terminate at ANC 202. ANC 202 may include one or more TRPs 208 (e.g., cells, BSs, gNBs, etc.).

The TRPs 208 may be a distributed unit (DU). TRPs 208 may be connected to a single ANC (e.g., ANC 202) or more than one ANC (not illustrated). For example, for RAN sharing, radio as a service (RaaS), and service specific AND deployments, TRPs 208 may be connected to more than one ANC. TRPs 208 may each include one or more antenna ports. TRPs 208 may be configured to individually (e.g., dynamic selection) or jointly (e.g., joint transmission) serve traffic to a UE.

The logical architecture of distributed RAN 200 may support fronthauling solutions across different deployment types. For example, the logical architecture may be based on transmit network capabilities (e.g., bandwidth, latency, and/or jitter).

The logical architecture of distributed RAN 200 may share features and/or components with LTE. For example, next generation access node (NG-AN) 210 may support dual connectivity with NR and may share a common fronthaul for LTE and NR.

The logical architecture of distributed RAN 200 may enable cooperation between and among TRPs 208, for example, within a TRP and/or across TRPs via ANC 202. An inter-TRP interface may not be used.

Logical functions may be dynamically distributed in the logical architecture of distributed RAN 200. The Radio Resource Control (RRC) layer, Packet Data Convergence Protocol (PDCP) layer, Radio Link Control (RLC) layer, Medium Access Control (MAC) layer, and a Physical (PHY) layers may be adaptably placed at the DU (e.g., TRP 208) or CU (e.g., ANC 202).

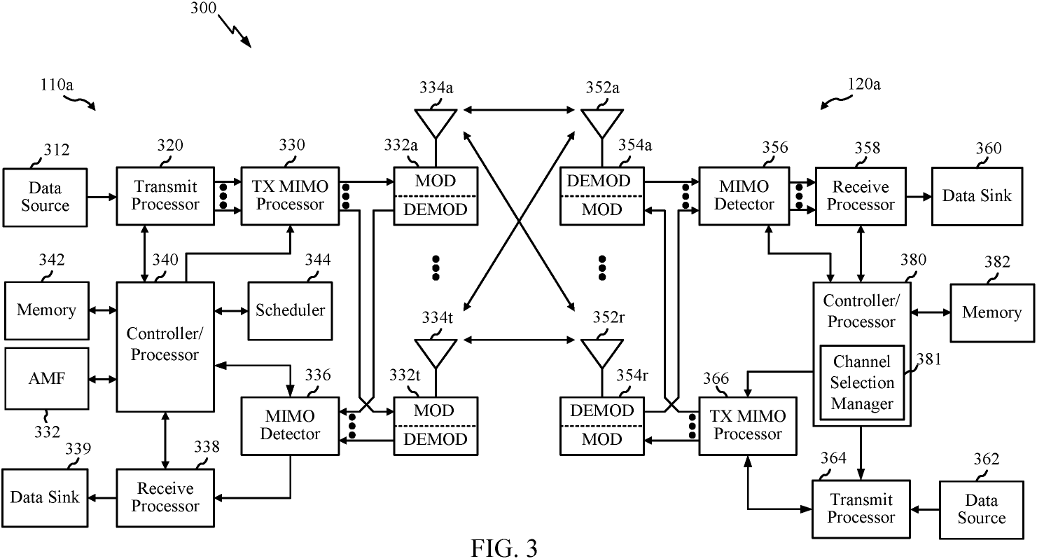

FIG. 3 illustrates example components of BS 110a and UEs 120a and/or 120b (as depicted in FIG. 1), which may be used to implement aspects of the present disclosure. For example, antennas 352, processors 366, 358, 364, and/or controller/processor 380 of the UE 120a and/or UE 120b may be used to perform the various techniques and methods described herein with reference to FIGS. 6, 8, and/or 14. Similarly, antennas 334, processors 320, 338, 330, and/or controller/processor 340 of the BS 110a may be used to perform the various techniques and methods described herein.

At the BS 110a, a transmit processor 320 may receive data from a data source 312 and control information from a controller/processor 340. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 320 may process (e.g., encode and symbol map) the data and control information to obtain data symbols and control symbols, respectively. The processor 320 may also generate reference symbols, e.g., for the primary synchronization signal (PSS), secondary synchronization signal (SSS), and cell-specific reference signal (CRS). A transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) 332a through 332t. Each modulator 332 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 332a through 332t may be transmitted via the antennas 334a through 334t, respectively.

At the UE 120a (and/or 120b), the antennas 352a through 352r may receive the downlink signals from the BS 110a and may provide received signals to the demodulators (DEMODs) in transceivers 354a through 354r, respectively. Each demodulator 354 may condition (e.g., filter, amplify, downconvert, and digitize) a respective received signal to obtain input samples. Each demodulator may further process the input samples (e.g., for OFDM, etc.) to obtain received symbols. A MIMO detector 356 may obtain received symbols from all the demodulators 354a through 354r, perform MIMO detection on the received symbols if applicable, and provide detected symbols. A receive processor 358 may process (e.g., demodulate, deinterleave, and decode) the detected symbols, provide decoded data for the UE 120a (or 120b) to a data sink 360, and provide decoded control information to a controller/processor 380.

On the uplink, at UE 120a (and/or 120b), a transmit processor 364 may receive and process data (e.g., for the physical uplink shared channel (PUSCH)) from a data source 362 and control information (e.g., for the physical uplink control channel (PUCCH) from the controller/processor 380. The transmit processor 364 may also generate reference symbols for a reference signal (e.g., for the sounding reference signal (SRS)). The symbols from the transmit processor 364 may be precoded by a TX MIMO processor 366 if applicable, further processed by the demodulators in transceivers 354a through 354r (e.g., for SC-FDM, etc.), and transmitted to the BS 110a. At the BS 110a, the uplink signals from the UE 120a (and/or 120b) may be received by the antennas 334, processed by the modulators 332, detected by a MIMO detector 336 if applicable, and further processed by a receive processor 338 to obtain decoded data and control information sent by the UE 120a (and/or 120b). The receive processor 338 may provide the decoded data to a data sink 339 and the decoded control information to the controller/processor 340.

The controllers/processors 340 and 380 may direct the operation at the BS 110a and the UE 120a (and/or 120b), respectively. The processor 340 and/or other processors and modules at the BS 110a may perform or direct the execution of processes for the techniques described herein. As shown in FIG. 2, the controller/processor 380 of the UE 120a (and/or 120b) has a channel selection manager 381 that may be configured for perform operations FIGS. 6, 8, and/or 14. Although shown at the controller/processor 380 and controller/processor 340, other components of the UE 120a (and/or 120b) and BS 110a may be used performing the operations described herein. The memories 342 and 382 may store data and program codes for BS 110a and UE 120a (and/or 120b), respectively. A scheduler 344 may schedule UEs for data transmission on the downlink, sidelink, and/or uplink.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks (WLANs), which may use an unlicensed spectrum).

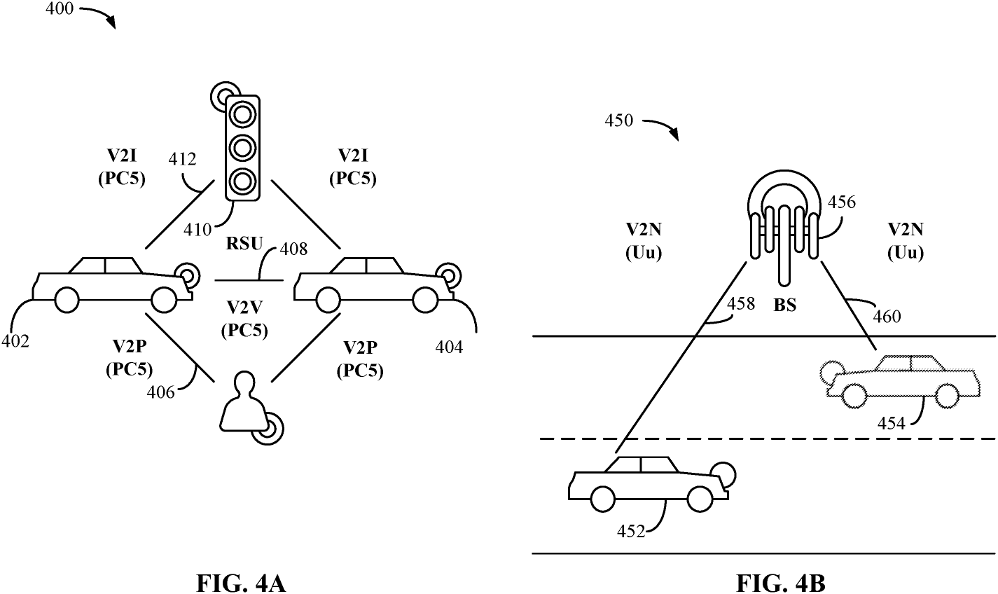

FIG. 4A and FIG. 4B show diagrammatic representations of example vehicle-to-everything (V2X) systems, in accordance with some aspects of the present disclosure. For example, the vehicles shown in FIG. 4A and FIG. 4B may communicate via sidelink channels and may relay sidelink transmissions as described herein.

The V2X systems provided in FIG. 4A and FIG. 4B provide two complementary transmission modes. A first transmission mode (also referred to as mode 4), shown by way of example in FIG. 4A, involves direct communications (for example, also referred to as sidelink communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle-to-vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation. An unlicensed spectrum refers to any frequency band(s) that are not subject to licensed use under regulatory practice, such that the frequency band(s) are open to use by any devices, and not just devices that have a license to use the particular frequency band(s).

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 460 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can rebroadcasts critical information received from some UEs. UE-type RSUs may be a reliable synchronization source.

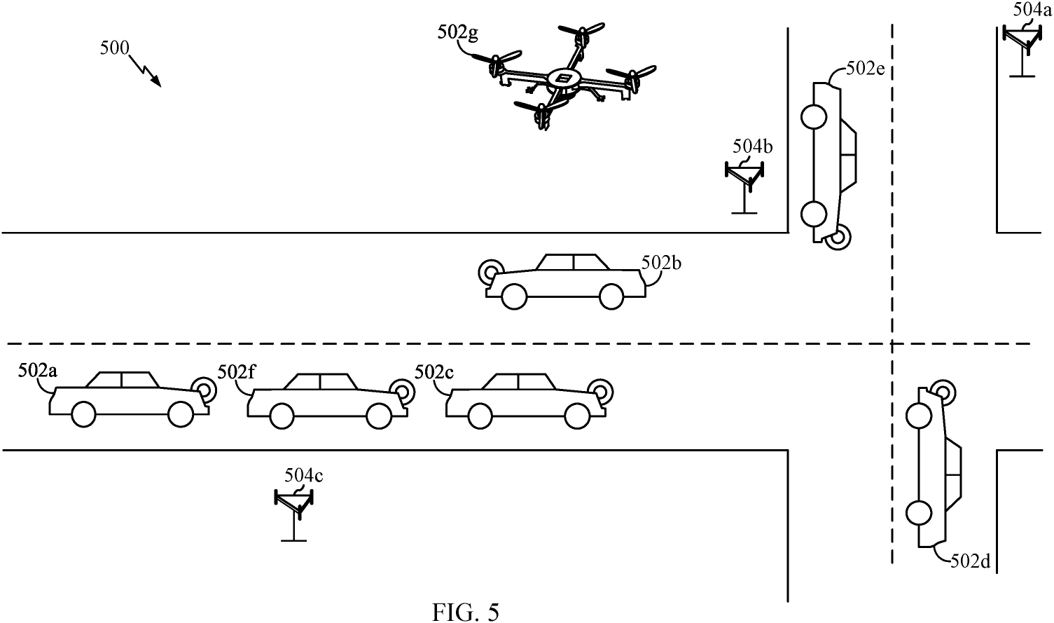

FIG. 5 is a schematic diagram illustrating an example network 500 of multiple CV2X devices operating in an unlicensed spectrum. The unlicensed spectrum may be an example of a sidelink frequency band. Further, the network 500 may be an example of a sidelink communication system. The CV2X devices 502 may be configured to communicate on sidelink frequency channels as discussed herein. For example, any of the CV2X devices 502 may communicate with any other of the CV2X devices 502.

In the illustrated example, seven CV2X devices (e.g., a first CV2X device 502a, a second CV2X device 502b, a third CV2X device 502c, a fourth CV2X device 502d, a fifth CV2X device 502e, a sixth CV2X device 502f, and a seventh CV2X device 502g) - collectively referred to as CV2X devices 502) may operate in an unlicensed spectrum with other non-CV2X devices (e.g., non-CV2X devices 504a-c - collectively referred to as non-CV2X devices 504). In some examples, the first CV2X device 502a, the sixth CV2X device 502f, and the third CV2X device 502c may be part of a fleet or platoon. In transportation, platooning or flocking is a method for driving a group of vehicles together. It is meant to increase the capacity of roads via an automated highway system. Platoons decrease the distances between cars or trucks, such as based on sidelink communications.

Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 502 may include UEs (e.g., UE 120 of FIG. 1) and/or road-side units (RSUs) operated by a highway authority, and may be devices implemented on motorcycles or carried by users (e.g., pedestrian, bicyclist, etc.), or may be implemented on another aerial vehicle such as a helicopter.

The CV2X devices 502 may include UEs (e.g., UE 120 of FIG. 1), and may be devices implemented on motorized vehicles (such as an automobile, motorcycle, etc.) or carried by users (e.g., pedestrian, bicyclist, etc.), or implemented as a roadside unit.

Various sidelink channels may be used for sidelink communications, including a physical sidelink discovery channel (PSDCH), a physical sidelink control channel (PSCCH), a physical sidelink shared channel (PSSCH), and a physical sidelink feedback channel (PSFCH). The PSDCH may carry discovery expressions that enable proximal devices to discover each other. The PSCCH may carry control signaling such as sidelink resource configurations and other parameters used for data transmissions, and the PSSCH may carry the data transmissions.

For the operation regarding PSSCH, a UE performs either transmission or reception in a slot on a carrier. A reservation or allocation of transmission resources for a sidelink transmission may be made on a sub-channel of a frequency band for a period of a slot. NR sidelink supports for a UE a case where all the symbols in a slot are available for sidelink, as well as another case where only a subset of consecutive symbols in a slot is available for sidelink.

PSFCH may carry feedback such as channel state information (CSI) related to a sidelink channel quality. A sequence-based PSFCH format with one symbol (not including AGC training period) may be supported. The following formats may be possible: a PSFCH format based on PUCCH format 2 and a PSFCH format spanning all available symbols for sidelink in a slot.

### Example Carrier Selection in a Distributive Dual Band CA System

Certain wireless systems may be designed to operate on certain frequency bands. For example, long term evolution (LTE) vehicle-to-everything (V2X) may target a licensed 5.9 GHz frequency band (e.g., band B47), with an allocated bandwidth of 20 MHz. Spectrum scarcity for some systems may lead to considering unlicensed frequency bands. For example, new radio (NR) V2X (e.g., in the US market) has prompted exploration of the possibility to deploy NR V2X in the unlicensed band.

In some cases, it may be beneficial to deploy a dual connectivity system that could enjoy the best of both worlds: the reliability of a licensed band and the availability of large spectrum in the unlicensed band (along with the enhancements of the NR V2X design).

In deployments in the unlicensed band, carrier selection may play a central role in the successful coexistence with other technologies. For example, both licensed assisted access (LAA) and NR unlicensed (NRU) deployments rely on carrier selection to avoid certain channels, such as channels with heavy wireless local area network (WLAN) activity, to minimize mutual interference.

In LAA and NRU however, the carrier selection may be performed by a base station (BS) based on channel sensing. As a result, all UEs tune into the selected channel, by searching for the BS synchronization signal block (SSB) once and remaining on that channel afterwards.

In distributive systems, however, channel sensing is done by each UE independently. Thus, the result is not the same for all the UEs, as different UEs can individually select different channels. Aspects of the present disclosure, however, provide a mechanism that allows all UEs within a range (e.g., in an immediate vicinity of each other, for example, as defined by a given range or threshold distance which may be inferred by ZoneIDs) to settle on a same channel and be able to communicate with each other.

FIG. 6 illustrates example operations 600 for wireless communications by a UE, in accordance with certain aspects of the present disclosure. For example, operations 600 may be performed by a V-UE (e.g., implemented as a UE 120 of FIG. 1 or FIG. 4, and/or as the vehicle 502 or 504 of FIG. 5A) to efficiently coordinate channels for communicating with other V-UEs.

Operations 600 begin, at 602, by selecting at least a first channel within an unlicensed band for communications with at least a second UE. In some cases, the UE monitors the unlicensed (frequency) band, and the selection of the first channel may be based on such monitoring. At 604, the UE transmits, on a licensed band, an indication of the first channel and location information for the selection. In some cases, the transmission of the indication of the first channel and location information may be considered “advertising” of such information.

In this manner, a UE may select a preferred channel (e.g., the best channel from the UE’s perspective based on channel quality metrics) in the unlicensed band for communication and advertise the channel selection on the licensed (e.g., LTE V2X) carrier. In some cases, a channel selection algorithm may be designed as what may be considered a “best effort procedure” for all or most UEs in the immediate vicinity (e.g., within a given range as indicated by zone IDs included in sidelink transmissions by those UEs) of each other to use the same channel in the unlicensed band. The channel selection algorithm may be designed to facilitate broadcast/multicast communication between V-UEs within a given range/proximity, and allow simplified implementation.

Depending on the UE implementation, the algorithm may still function properly even if not all devices are using the same unlicensed channel. This may be accomplished because channel numbers (indicating selected channels) advertised over the licensed band (e.g., LTE) can still be used to tune into a specific unlicensed channel to communicate with a group of UEs (e.g., 2 or more) using that particular channel.

The techniques described herein, whereby a UE advertises a selected carrier (or channel) selection for the benefit of other UEs, may be considered a form of distributed channel selection. One potential objective of such distributed carrier (channel) selection as proposed herein may be to achieve location-dependent channel selection, for a group of UEs in a given range, for example, based on local interference patterns and WLAN deployments.

In distributed synchronized systems, certain synchronized sources (e.g., global positioning system (GPS) synchronized sources) are assigned higher priority. Aspects of the present disclosure may assign certain V-UEs, such as stationary nodes (e.g., RSUs), higher priority in the carrier selection process. This preference may be given, for example, because (as the name implies) RSUs typically remain in a given location and provide a fixed reference point for channel conditions.

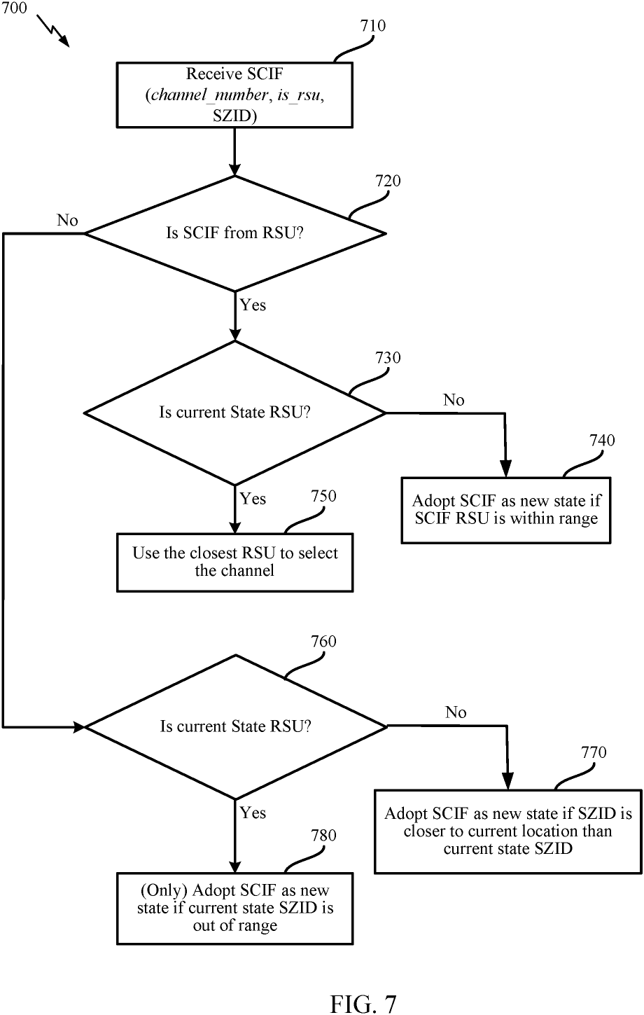

FIG. 7 illustrates one example of a channel selection algorithm 700 in accordance with the present disclosure. In some cases, the channel selection algorithm 700 may be implemented by a V-UE performing operations 600 of FIG. 6.

The algorithm may be performed at each UE (V-UE/RSU), as each UE periodically monitors the unlicensed band for a “clean” channel (e.g., with the least interference at a current location) to use for (e.g., NR) V2X transmission/reception (TX/RX) operations on the unlicensed frequency band, while concurrently performing (e.g., LTE) V2X operations on the licensed band. In this context, concurrent operation does not necessarily mean simultaneous communication but could refer to overlapping or interleaved communication in licensed bands (e.g., LTE V2X) and unlicensed bands (e.g., NR V2X).

On the licensed frequency (e.g., LTE carrier), each NR V2X device may periodically transmit a Secondary Carrier Information Field (SCIF) that, nay in one example, carry the following information:
channel number: the “clean” channel number (that identifies a channel on the unlicensed carrier where the UE transmits/receives);
is_RSU field: specifies if the device (transmitting the SCIF) is a stationary/RSU device; and
SZID: the Selected Zone Identifier (ID) (corresponding to a geographic location) where the carrier selection was made.
The is_RSU field may serve to indicate an SCIF is sent by an RSU (e.g., is_RSU = 1), allowing channel selection by an RSU to be prioritized because an RSU (being stationary) may operate to monitor unlicensed channels over a relatively long period of time.

Referring to FIG. 7, at any given time, a UE keeps a current state defined as: {channel_number, is_RSU, SZID}, indicating the currently used channel, whether the channel was selected by a RSU, and where the channel was selected (e.g., a zone in which the V-UE/RSU that selected the channel was at the time of the selection). This location information can help a UE decide if it is within a given range and, therefore, whether using a corresponding advertised channel makes sense.

As shown in the channel selection algorithm 700, for any SCIF received, at 710, the UE determines, at 720, if the SCIF was sent by an RSU. If the SCIF was sent by an RSU, the UE checks, at 730, to see if the current state channel selection was also obtained from an SCIF sent by an RSU. If yes, at 750, the UE uses the closest RSU to select the channel (e.g., as determined by current state and SCIF zone IDs). If the current channel selection was not obtained from a SCIF from a RSU, and the current SCIF is from an RSU, the UE, at 740, adopts the SCIF as a new state, for example, provided that the SCIF RSU is within a certain (e.g., pre-configured) range.

Referring back to 720, if the current SCIF (which was received at 710) was sent by a non-RSU (e.g., a mobile V-UE), then the UE determines (at 760) if the current channel selection is from an RSU. If yes, at 780 the UE (only) adopts the SCIF as a new state if the current state RSU is out of range (e.g., the V-UE has traveled at least a threshold distance away from the zone ID of the current SCIF state). If the current channel selection is not from an RSU, the UE, at 770, adopts the state of the received SCIF as a new state if the SZID of the SCIF (e.g., scif.SZID) is closer to the current location than current SZID (e.g., state. SZID). If the zone IDs (of the current state and received SCIF) are the same, the UE may employ some form of tiebreaker (e.g., using a higher frequency channel).

If no SCIF within the configured range is received from other UEs over a configured period of time, the UE may go through the carrier selection process (e.g., scanning unlicensed frequency band) to pick the best channel, and transmit its own SCIF containing { channel _number, is_rsu = 0, SZID} (e.g., where, the SZID is the Zone ID where the selection was made).

FIG. 8 illustrates example operations 800 for wireless communications by a UE, in accordance with certain aspects of the present disclosure. For example, operations 800 may be performed by a V-UE (e.g., implemented as a UE 120 of FIG. 1 or FIG. 4, and/or as the vehicle 502 or 504 of FIG. 5A) to efficiently coordinate channels for communicating with other V-UEs, such as the V-UE performing operations 600 of FIG. 6.

Operations 800 begin, at 802, by receiving, from a second UE on a licensed band, a first indication of a first channel within an unlicensed band for communications with the second UE. At 804, the UE transmits, on the licensed band, an indication of a preferred channel and location information for the preferred channel, wherein the preferred channel comprises the first channel or a second channel.

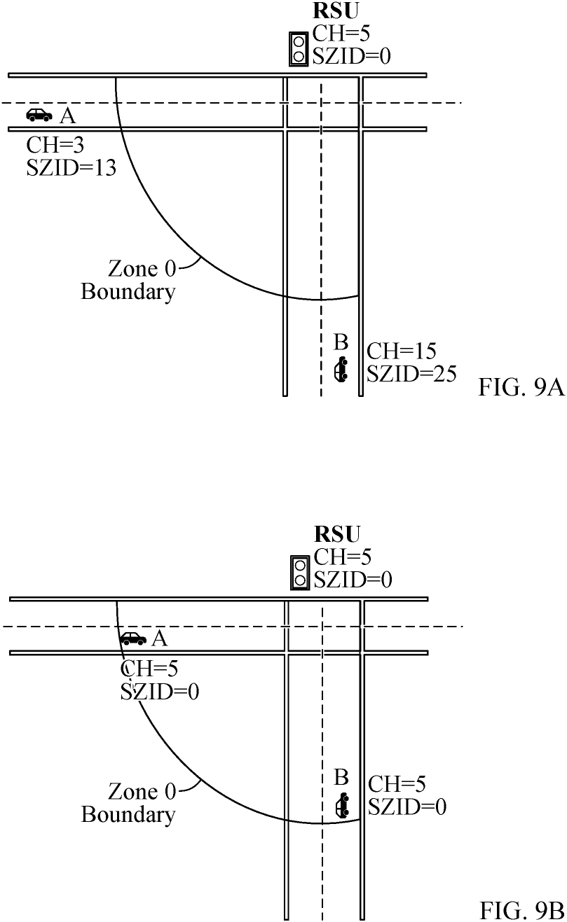

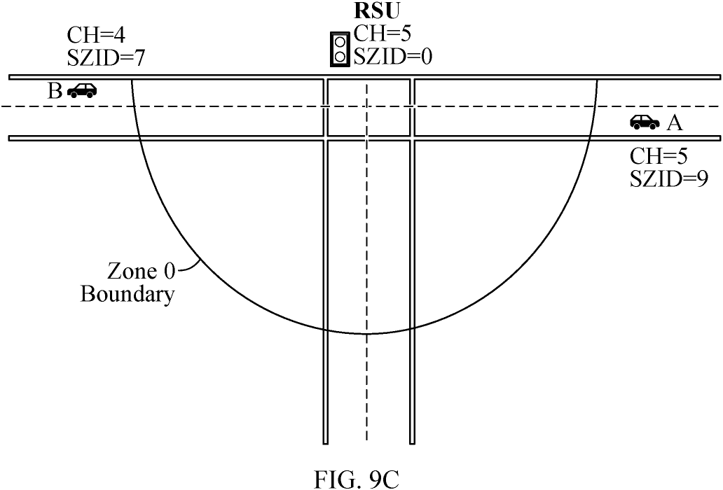

FIGS. 9A-9C, 10A-10B, and 11A-11B illustrate various scenarios for practical application of the algorithm described above.

FIGS. 9A-9C illustrate a scenario where two cars (A and B) cross an intersection that has an RSU (on channel 5 with a SZID of 0). FIG. 9A first illustrates an example with two cars (e.g., V-UEs) that are out of range for RSUs. In other words, both cars A and B are outside of the Zone 0 Boundary, as shown. Furthermore, both cars A and B have selected different channels in the unlicensed band at different locations. That is, Car A selects channel 3 and has a SZID of 13, and Car B selects channel 15 and has a SZID of 25. As illustrated in FIG. 9B, as the cars A and B come within the RSU range (within Zone 0 Boundary), they adopt the RSU channel and the SZID (e.g., CH=5 and SZID=0).

As illustrated in FIG. 9C, as the cars A and B travel out of range of the Zone 0 Boundary of the RSU (or the RSU is otherwise lost/disconnected), the cars A and B may either perform re-selection or switch to channels advertised by other UEs (not shown). In the illustrated example, the cars A and B switch to CH=5/SZID=9 and CH=4/SZID=7, respectively.

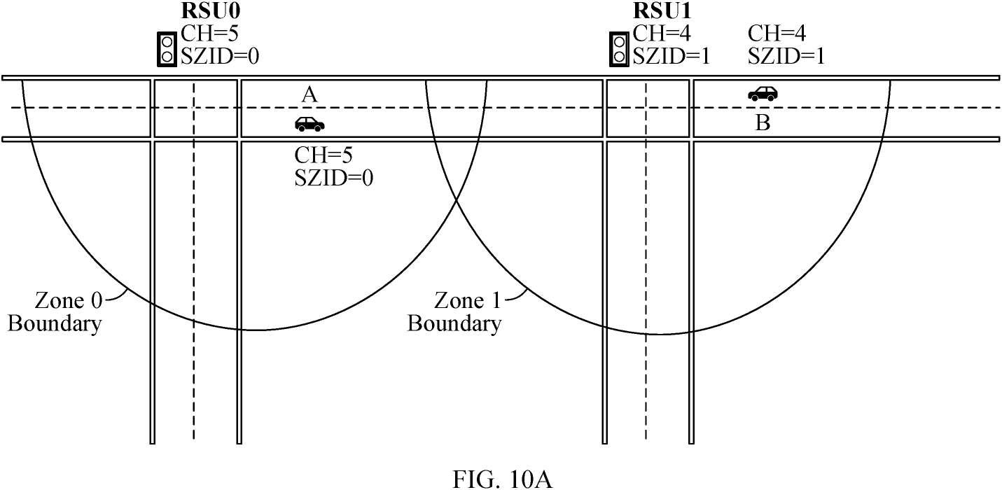

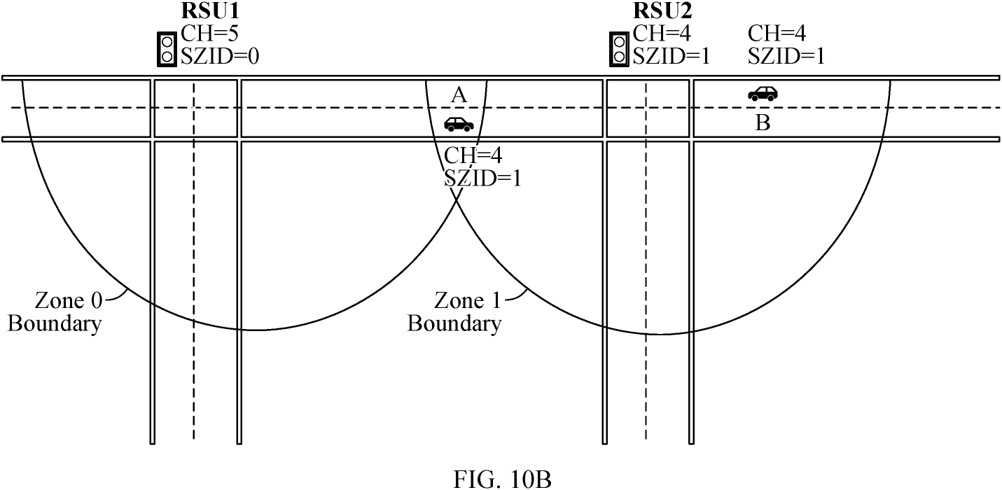

FIGS. 10A-10B illustrate another scenario where car A passes from one RSU (Zone 0 Boundary) to another RSU (while car B remains in the RSU Zone 1 Boundary). In FIG. 10A, car A is closest to a first RSU (RSU 0) and, thus uses the SCIF of that RSU (e.g., CH=5 and SZID=0 as in FIGS. 9A-9C). Similarly, car B is closest to a second RSU (RSU 1) and, thus uses the SCIF of that RSU (e.g., CH=4 and SZID=1). As illustrated, in FIG. 10B, as car A moves to be closer to the second RSU (RSU 1), car A updates its SCIF state to that advertised by the new/closer RSU 1 (e.g., CH=4 and SZID=1).

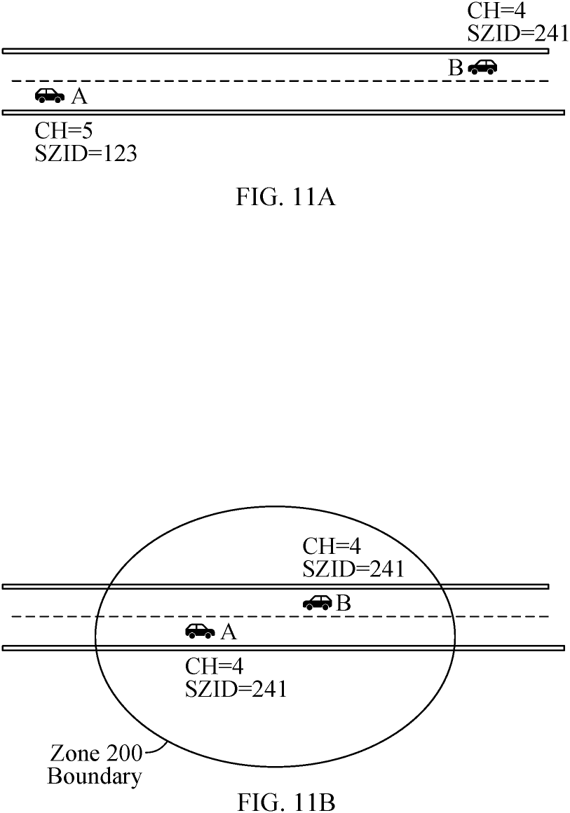

FIGS. 11A and 11B illustrate how UE channel selection may merge when there are no RSUs in range. As illustrated in FIG. 11A, two cars A and B coming towards each other, each with a different channel, and a different SZID (e.g., car A has CH=5 and SZID=123, and car B has CH=4 and SZID=241).

As illustrated in FIG. 11B, when the cars meet (e.g., come within range of each other), the UEs may apply the criteria of which SZID is closer, in terms of distance, to a current Zone ID. In other words, the car that made a channel selection at a more distant point (farther away) from the current location may give up its selection and adopt the channel of the other car (as that channel selection was made closer to the current location). In the illustrated example, the current zone ID is 200 (which is closer to 241 than 123), therefore car A that previously had CH=5 and SZID=123 switches to CH=4 and SZID=241.

While the examples described above involved 2 cars, the distributed channel selection described herein can be expanded to scenarios with more than 2 cars (e.g., as shown in FIG. 5). In such cases, each car within range may receive advertisements from one or more other UEs (and/or advertise its own channel selections) and perform a channel selection algorithm accordingly. In this manner a group of more than 2 UEs may be able to settle on a common channel for V2X communications.

### Example Communications Devices

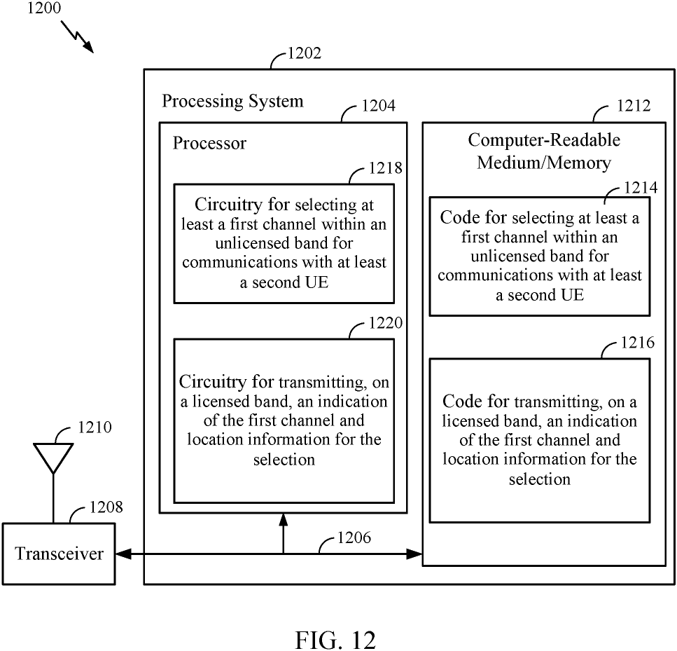

FIG. 12 illustrates a communications device 1200 that may include various components (e.g., corresponding to means-plus-function components) configured to perform operations for the techniques disclosed herein, such as the operations illustrated in FIG. 6. The communications device 1200 includes a processing system 1202 coupled to a transceiver 1208. The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 6, or other operations for efficiently coordinating channels for communicating with other V-UEs. In certain aspects, computer-readable medium/memory 1212 stores code 1214 for selecting at least a first channel within an unlicensed band for communications with at least a second UE; and code 1216 for transmitting, on the licensed band, an indication of the first channel and location information for the selection. In certain aspects, the processor 1204 has circuitry configured to implement the code stored in the computer-readable medium/memory 1212. The processor 1204 includes circuitry 1218 for selecting at least a first channel within an unlicensed band for communications with at least a second UE; and circuitry 1220 for transmitting, on a licensed band, an indication of the first channel and location information for the selection.

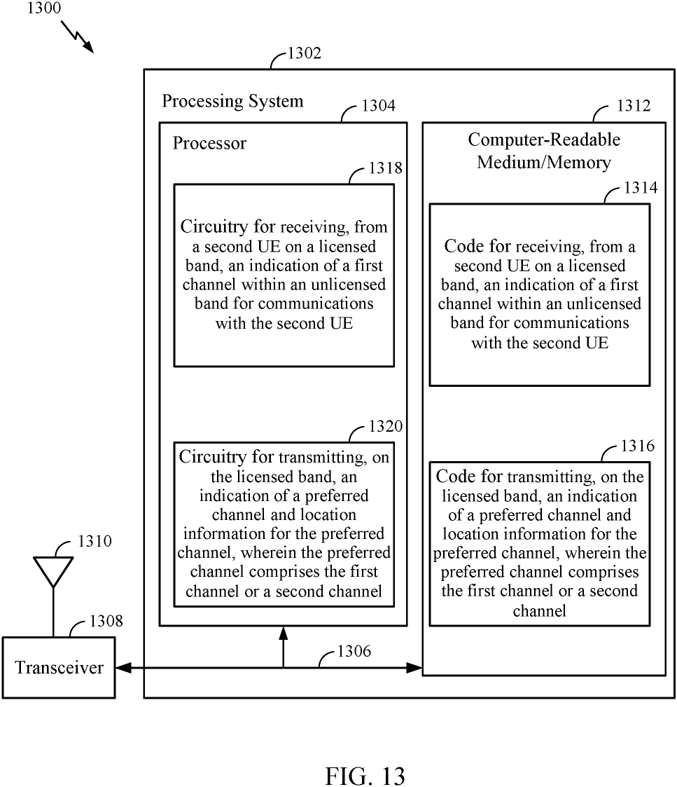

FIG. 13 illustrates a communications device 1300 that may include various components (e.g., corresponding to means-plus-function components) configured to perform operations for the techniques disclosed herein, such as the operations illustrated in FIG. 8. The communications device 1300 includes a processing system 1302 coupled to a transceiver 1308. The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 8, or other operations for efficiently coordinating channels for communicating with other V-UEs. In certain aspects, computer-readable medium/memory 1312 stores code 1314 for receiving, from a second UE on a licensed band, a first indication of a first channel within an unlicensed band for communications with the second UE; and code 1316 for transmitting, on a licensed band, an indication of a preferred channel and location information for the preferred channel, wherein the preferred channel comprises the first channel or a second channel. In certain aspects, the processor 1304 has circuitry configured to implement the code stored in the computer-readable medium/memory 1312. The processor 1304 includes circuitry 1318 for receiving, from a second UE on a licensed band, a first indication of a first channel within an unlicensed band for communications with the second UE; and circuitry 1320 for transmitting, on a licensed band, an indication of a preferred channel and location information for the preferred channel, wherein the preferred channel comprises the first channel or a second channel.

### Example Method(s)

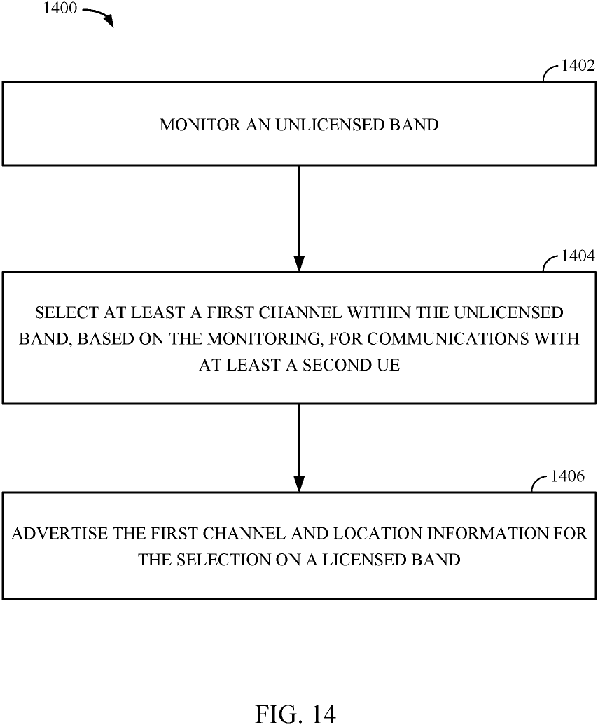

FIG. 14 illustrates example operations 1400 for wireless communications by a UE, in accordance with certain aspects of the present disclosure. For example, operations 1400 may be performed by a UE 120 of FIG. 1 or FIG. 4 when performing sidelink communications.

Operations 1400 begin, at 1402, by monitoring an unlicensed band. At 1404, the UE selects at least a first channel within the unlicensed band, based on the monitoring, for communications with at least a second UE. At 1406, the UE advertises the first channel and location information for the selection on a licensed band.

### Example Aspects

Aspect 1: A method for wireless communications by a first user equipment (UE), comprising selecting at least a first channel within an unlicensed band for communications with at least a second UE, and transmitting, on a licensed band, an indication of the first channel and location information for the selection.

Aspect 2: The method of Aspect 1, wherein the transmitting comprises periodically transmitting an indication of the first channel and location information in a secondary carrier information field (SCIF).

Aspect 3: The method of Aspect 2, wherein the SCIF includes a channel number identifying the first channel, a field indicating whether the first UE is a stationary device, and a selected zone ID, as the location information, indicating a zone ID where the first channel was selected as the location information.

Aspect 4: The method of Aspect 3, further comprising receiving, on the licensed band, at least one SCIF from at least the second UE, and communicating with the second UE via the first channel selected by the first U, or a second channel indicated in the SCIF received from the second UE.

Aspect 5: The method of Aspect 4, wherein the communicating with the second UE via the first channel or the second channel is based, at least in part, on whether the received SCIF indicates the second UE is a stationary unit, and a selected zone ID in the SCIF received from the second UE.

Aspect 6: The method of Aspect 5, wherein communicating via the first channel or the second channel comprises communicating via the second channel if the SCIF received from the second UE indicates the second UE is a stationary unit and the selected zone ID in the SCIF received from the second UE is within a configured range.

Aspect 7: The method of Aspect 6, further comprising receiving SCIFs from other stationary unit UEs with selected zone IDs within the configured range, and selecting a channel indicated in an SCIF received from a closest of the stationary unit UEs.

Aspect 8: The method of any of Aspects 5-7, wherein the first UE communicates via the second channel indicated in the SCIF received from the second UE only if the zone ID in the SCIF received from the second UE indicates the second UE is within a configured range.

Aspect 9: The method of Aspect 8, further comprising receiving SCIFs from other UEs within the configured range, and selecting a channel indicated in one of the SCIFs with a highest frequency channel.

Aspect 10: The method of any of Aspects 4-9, wherein, if the second UE is not a stationary unit, communicating with the second UE via the first channel or the second channel comprises communicating with the second UE via the first channel if the selected zone ID in the SCIF transmitted by the first UE is closer, in terms of distance, to a current zone ID than the selected zone ID in the SCIF received from the second UE, or communicating with the second UE via the second channel if the selected zone ID in the SCIF received from the second UE is closer, in terms of distance, to a current zone ID than the selected zone ID in the SCIF transmitted by the first UE.

Aspect 11: A method for wireless communications by a first UE, comprising receiving, from a second UE on a licensed band, a first indication of a first channel within an unlicensed band for communications with the second UE, and transmitting, on a licensed band, an indication of a preferred channel and location information for the preferred channel, wherein the preferred channel comprises the first channel or a second channel.

Aspect 12: The method of Aspect 11, wherein the receiving comprises periodically receiving an indication of the first channel and location information in a SCIF.

Aspect 13: The method of Aspect 12, wherein the SCIF includes a channel number identifying the first channel, a field indicating whether the first UE is a stationary device, and a selected zone ID, as the location information, indicating a zone ID of the first channel as the location information.

Aspect 14: The method of Aspect 13, wherein transmitting the indication of the preferred channel comprises transmitting, on the licensed band, at least one SCIF to at least the second UE, and the method further comprising communicating with the second UE via the first channel, or the second channel indicated in the SCIF transmitted to the second UE.

Aspect 15: The method of Aspect 14, wherein the communicating with the second UE the first channel or the second channel is based, at least in part, on whether the transmitted SCIF indicates the first UE is a stationary unit, and a selected zone ID in the SCIF transmitted to the second UE.

Aspect 16: The method of Aspect 15, wherein communicating with the second UE via the first channel or the second channel comprises communicating via the second channel if the SCIF transmitted to the second UE indicates the first UE is a stationary unit and the selected zone ID in the SCIF transmitted to the second UE is within a configured range.

Aspect 17: The method of Aspect 15 or 16, wherein the first UE communicates via the second channel indicated in the SCIF transmitted to the second UE only if the zone ID in the SCIF transmitted to the second UE indicates the second UE is within a configured range.

Aspect 18: The method of any of Aspects 14-17, wherein, if the first UE is not a stationary unit, communicating with the second UE via the first channel or the second channel comprises communicating via the first channel if the selected zone ID in the SCIF received from the second UE is closer, in terms of distance, to a current zone ID than the selected zone ID in the SCIF transmitted to the second UE, or communicating via the second channel if the selected zone ID in the SCIF transmitted to the second UE is closer, in terms of distance, to a current zone ID than the selected zone ID in the SCIF received from the first UE.

Aspect 19. A method for wireless communications by a first user equipment (UE), comprising monitoring an unlicensed band; selecting at least a first channel within the unlicensed band, based on the monitoring, for communications with at least a second UE; and advertising the first channel and location information for the selection on a licensed band.

Aspect 20. The method of Aspect 19, wherein the advertising comprises periodically transmitting an indication of the first channel and location information in a secondary carrier information field (SCIF).

Aspect 21. The method of Aspect 20, wherein the SCIF includes a channel number identifying the first channel; a field indicating whether the first UE is a stationary device; and a selected zone ID, as the location information, indicating a zone ID where the first channel was selected as the location information.

Aspect 22. The method of Aspect 21, further comprising receiving, on the licensed band, at least one SCIF from at least the second UE; and deciding whether to use the first channel selected by the first UE or a second channel indicated in the SCIF received from the second UE for communications with the second UE.

Aspect 23. The method of Aspect 22, wherein the decision is based, at least in part, on whether the received SCIF indicates the second UE is a stationary unit; and a selected zone ID in the SCIF received from the second UE.

Aspect 24. The method of Aspect 23, wherein deciding whether to use the first channel or the second channel comprises deciding to use the second channel if the SCIF received from the second UE indicates the second UE is a stationary unit and the selected zone ID in the SCIF received from the second UE is within a configured range.

Aspect 25. The method of Aspect 24, further comprising receiving SCIFs from other stationary unit UEs with selected zone IDs within the configured range; and selecting a channel indicated in an SCIF received from a closest of the stationary unit UEs.

Aspect 26. The method of any of Aspects 23-25, wherein the decision is to use the channel indicated in the SCIF received from the second UE only if the zone ID in the SCIF received from the second UE indicates the second UE is within a configured range.

Aspect 27. The method of Aspect 26, further comprising receiving SCIFs from other UEs within the configured range; and selecting a channel indicated in one of the SCIFs with a highest frequency channel.

Aspect 28. The method of any of Aspects 22-27, wherein, if the second UE is not a stationary unit, deciding whether to use the first channel or the second channel comprises deciding to use the first channel if the selected zone ID in the SCIF transmitted by the first UE is closer, in terms of distance, to a current zone ID than the selected zone ID in the SCIF received from the second UE; or deciding to use the second channel if the selected zone ID in the SCIF received from the second UE is closer, in terms of distance, to a current zone ID than the selected zone ID in the SCIF transmitted by the first UE.

Aspect 29: An apparatus for wireless communication comprising a processor, memory coupled with the processor, the processor and memory configured to perform a method of any one of Aspects 1-28.

Aspect 30: An apparatus for wireless communication comprising at least one means for performing a method of any one of Aspects 1-28.

Aspect 31: A non-transitory computer-readable medium storing code for wireless communication comprising a processor, memory coupled with the processor, and instructions stored in the memory and executable by the processor to cause the apparatus to perform a method of any one of Aspects 1-28.

Aspect 32: A method for wireless communications by a first user equipment (UE), comprising monitoring an unlicensed band; selecting at least a first channel within the unlicensed band, based on the monitoring, for communications with at least a second UE; and advertising the first channel and location information for the selection on a licensed band.

Aspect 33: The method of Aspect 32, wherein the advertising comprises periodically transmitting an indication of the first channel and location information in a secondary carrier information field (SCIF).

Aspect 34: The method of Aspect 33, wherein the SCIF includes: a channel number identifying the first channel; a field indicating whether the first UE is a stationary device; and a selected zone ID, as the location information, indicating a zone ID where the first channel was selected as the location information.

Aspect 35: The method any one of Examples 32 through 34, further comprising: receiving, on the licensed band, at least one SCIF from at least the second UE; and deciding whether to use the first channel selected by the first UE or a second channel indicated in the SCIF received from the second UE for communications with the second UE.

Aspect 36: The method of any one of Aspects 32 through 35, wherein the decision is based, at least in part, on whether the received SCIF indicates the second UE is a stationary unit; and a selected zone ID in the SCIF received from the second UE.

Aspect 37: The method of any one of Aspects 32 through 36, wherein deciding whether to use the first channel or the second channel comprises: deciding to use the second channel if the SCIF received from the second UE indicates the second UE is a stationary unit and the selected zone ID in the SCIF received from the second UE is within a configured range.

Aspect 38: The method of any one of Aspects 32 through 37, further comprising: receiving SCIFs from other stationary unit UEs with selected zone IDs within the configured range; and selecting a channel indicated in an SCIF received from a closest of the stationary unit UEs.

Aspect 39: The method of any one of Aspects 32 through 38, wherein the decision is to use the channel indicated in the SCIF received from the second UE only if the zone ID in the SCIF received from the second UE indicates the second UE is within a configured range.

Aspect 40: The method of any one of Aspects 32 through 39, further comprising: receiving SCIFs from other UEs within the configured range; and selecting a channel indicated in one of the SCIFs with a highest frequency channel.

Aspect 41: The method of any one of Aspects 32 through 40, wherein, if the second UE is not a stationary unit, deciding whether to use the first channel or the second channel comprises: deciding to use the first channel if the selected zone ID in the SCIF transmitted by the first UE is closer, in terms of distance, to a current zone ID than the selected zone ID in the SCIF received from the second UE; or deciding to use the second channel if the selected zone ID in the SCIF received from the second UE is closer, in terms of distance, to a current zone ID than the selected zone ID in the SCIF transmitted by the first UE.

Aspect 42: An apparatus for wireless communication comprising a processor, memory coupled with the processor, the processor and memory configured to perform a method of any one of Examples 32 through 41.

Aspect 43: An apparatus for wireless communication comprising at least one means for performing a method of any one of Examples 32 through 41.

Aspect 44: A non-transitory computer-readable medium storing code for wireless communication comprising a processor, memory coupled with the processor, and instructions stored in the memory and executable by the processor to cause the apparatus to perform a method of any one of Aspects 32 through 41.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 6, 8, and/or 14 may be performed by various processors shown in FIG. 4 for UE 120a (and/or 120b) and/or BS 110a.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a UE 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 6, 8, and/or 14.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a first user equipment (UE), comprising:
selecting at least a first channel within an unlicensed band for communications with at least a second UE; and
transmitting, on a licensed band, an indication of the first channel and location information for the selection.

2. The method of claim 1, wherein the transmitting comprises periodically transmitting the indication of the first channel and location information in a secondary carrier information field (SCIF).

3. The method of claim 2, wherein the SCIF includes:
a channel number identifying the first channel;
a field indicating whether the first UE is a stationary device; and
a selected zone ID, as the location information, indicating a zone ID where the first channel was selected as the location information.

4. The method of claim 3, further comprising:
receiving, on the licensed band, at least one SCIF from at least the second UE; and
communicating with the second UE via:
the first channel selected by the first UE; or
a second channel indicated in the SCIF received from the second UE.

5. The method of claim 4, wherein the communicating with the second UE via the first channel or the second channel is based, at least in part, on:
whether the SCIF received from the second UE indicates the second UE is a stationary unit; and
a selected zone ID in the SCIF received from the second UE.

6. The method of claim 5, wherein communicating via the first channel or the second channel comprises:
communicating via the second channel when the SCIF received from the second UE indicates the second UE is a stationary unit and the selected zone ID in the SCIF received from the second UE is within a configured range.

7. The method of claim 6, further comprising:
receiving SCIFs from other stationary unit UEs with selected zone IDs within the configured range; and
selecting a channel indicated in an SCIF received from a closest of the stationary unit UEs.

8. The method of claim 5, wherein the first UE communicates via the second channel indicated in the SCIF received from the second UE when the zone ID in the SCIF received from the second UE indicates the second UE is within a configured range.

9. The method of claim 8, further comprising:
receiving SCIFs from other UEs within the configured range; and
selecting a channel indicated in one of the SCIFs based on its frequency.

10. The method of claim 4, wherein, when the second UE is other than a stationary unit, communicating with the second UE via the first channel or the second channel comprises:
communicating with the second UE via the first channel when the selected zone ID in the SCIF transmitted by the first UE is closer, in terms of distance, to a current zone ID than the selected zone ID in the SCIF received from the second UE; or
communicating with the second UE via the second channel when the selected zone ID in the SCIF received from the second UE is closer, in terms of distance, to a current zone ID than the selected zone ID in the SCIF transmitted by the first UE.

11. A method for wireless communications by a first user equipment (UE), comprising:
receiving, from a second UE on a licensed band, an indication of a first channel within an unlicensed band for communications with the second UE; and
transmitting, on the licensed band, an indication of a preferred channel and location information for the preferred channel, wherein the preferred channel comprises the first channel or a second channel.

12. The method of claim 11, wherein the receiving comprises periodically receiving the indication of the first channel and location information from the second UE in a secondary carrier information field (SCIF).

13. The method of claim 12, wherein the SCIF includes:
a channel number identifying the first channel;
a field indicating whether the first UE is a stationary device; and
a selected zone ID, as the location information, indicating a zone ID of the first channel as the location information.

14. The method of claim 13, wherein:
the transmitting comprises transmitting, on the licensed band, at least one SCIF to at least the second UE; and
the method further comprising communicating with the second UE via: the first channel; or the second channel indicated in the SCIF transmitted to at least the second UE.

15. The method of claim 14, wherein the communicating with the second UE via the first channel or the second channel is based, at least in part, on:
whether the SCIF transmitted to the second UE indicates the first UE is a stationary unit; and
a selected zone ID in the SCIF transmitted to the second UE.

16. The method of claim 15, wherein communicating with the second UE via the first channel or the second channel comprises:
communicating via the second channel if the SCIF transmitted to the second UE indicates the first UE is a stationary unit and the selected zone ID in the SCIF transmitted to the second UE is within a configured range.

17. The method of claim 15, wherein the first UE communicates via the second channel indicated in the SCIF transmitted to the second UE only if the zone ID in the SCIF transmitted to the second UE indicates the second UE is within a configured range.

18. The method of claim 14, wherein, if the first UE is not a stationary unit, communicating with the second UE via the first channel or the second channel comprises:
communicating via the first channel if the selected zone ID in the SCIF received from the second UE is closer, in terms of distance, to a current zone ID than the selected zone ID in the SCIF transmitted to the second UE; or
communicating via the second channel if the selected zone ID in the SCIF transmitted to the second UE is closer, in terms of distance, to a current zone ID than the selected zone ID in the SCIF received from the first UE.

19. An apparatus for wireless communications by a first user equipment (UE), comprising:
a memory; and
at least one processor coupled to the memory, the memory and the at least one processor configured to:
select at least a first channel within an unlicensed band for communications with at least a second UE; and
transmit, on a licensed band, an indication of the first channel and location information for the selection.

20. The apparatus of claim 19, wherein the memory and the at least one processor are further configured to transmit the indication by periodically transmitting the indication of the first channel and location information in a secondary carrier information field (SCIF).

21. The apparatus of claim 20, wherein the SCIF includes:
a channel number identifying the first channel;
a field indicating whether the first UE is a stationary device; and
a selected zone ID, as the location information, indicating a zone ID where the first channel was selected as the location information.

22. The apparatus of claim 21, wherein the memory and the at least one processor are further configured to:
receive, on the licensed band, at least one SCIF from at least the second UE; and
communicate with the second UE via:
the first channel selected by the first UE; or
a second channel indicated in the SCIF received from the second UE.

23. The apparatus of claim 22, wherein the memory and the at least one processor are further configured to communicate with the second UE via the first channel or the second channel based, at least in part, on:
whether the SCIF received from the second UE indicates the second UE is a stationary unit; and
a selected zone ID in the SCIF received from the second UE.

24. The apparatus of claim 23, wherein the memory and the at least one processor are further configured to communicate via the first channel or the second channel by communicating via the second channel if the SCIF received from the second UE indicates the second UE is a stationary unit and the selected zone ID in the SCIF received from the second UE is within a configured range.

25. An apparatus for wireless communications by a first user equipment (UE), comprising:
a memory; and
at least one processor coupled to the memory, the memory and the at least one processor configured to:
receive, from a second UE on a licensed band, an indication of a first channel within an unlicensed band for communications with the second UE; and
transmit, on the licensed band, an indication of a preferred channel and location information for the preferred channel, wherein the preferred channel comprises the first channel or a second channel.

26. The apparatus of claim 25, wherein the memory and the at least one processor are configured to receive the indication of the first channel by periodically receiving the indication of the first channel and location information in a secondary carrier information field (SCIF).

27. The apparatus of claim 26, wherein the SCIF includes:
a channel number identifying the first channel;
a field indicating whether the first UE is a stationary device; and
a selected zone ID, as the location information, indicating a zone ID of the first channel as the location information.

28. The apparatus of claim 27, wherein the memory and the at least one processor are configured to:
transmit the indication of the preferred channel by transmitting, on the licensed band, at least one SCIF to at least the second UE; and
communicate with the second UE via the first channel or the second channel indicated in the SCIF transmitted to the second UE.

29. The apparatus of claim 28, wherein the memory and the at least one processor are further configured to communicate with the second UE via the first channel or the second channel based, at least in part, on:
whether the SCIF transmitted to the second UE indicates the first UE is a stationary unit; and
a selected zone ID in the SCIF transmitted to the second UE.

30. The apparatus of claim 29, wherein the memory and the at least one processor are further configured to communicate with the second UE via the first channel or the second channel by communicating via the second channel if the SCIF transmitted to the second UE indicates the first UE is a stationary unit and the selected zone ID in the SCIF transmitted to the second UE is within a configured range.
